(19) United States
(12) Patent Application Publication
(10) Pub. No.: US 2004/0024812 A1
(43) Pub. Date: Feb. 5, 2004

(54) Content publication system for supporting real-time integration and processing of multimedia content including dynamic data, and method thereof

(76) Inventors: Chong Mok Park, Seoul (KR); Kook Hee Lee, Gyeonggi (KR)

Correspondence Address: CANTOR COLBURN, LLP, 55 GRIFFIN ROAD SOUTH, BLOOMFIELD, CT, 06002

(21) Appl. No.: 10/415,687

(22) PCT Filed: Nov. 5, 2001
(86) PCT No.: PCT/KR01/01867

(30) Foreign Application Priority Data
Nov. 8, 2000 (KR) 200066220

(51) Int. Cl. G06F 15/16

(52) U.S. Cl. 709/203; 709/246; 715/513

(57) ABSTRACT

A content publication system supporting real-time integration and processing of multimedia content including dynamic data is provided. The content publication system includes a repository having a content repository described by a predetermined internal expression, which is capable of integrating a plurality of static and dynamic content, in unit of containers, a converter object repository for storing output format conversion rules for different devices, and a media converter repository for converting multimedia data to be suitable for the characteristics of each device; and a service publication server for fetching a corresponding container from the content repository in response to a content request received from a web server, accessing dynamic content using dynamic content access information included in the fetched container, integrating the dynamic content with static content in real time converting the integrated content according to an output format conversion rule fetched from the converter object repository for a corresponding device, converting multimedia data using a multimedia converter, and transmitting the result of conversion to the web server for the delivery to the device. Accordingly, a service producer can utilize dynamic data from various sources without the burden of content conversion which is different depending on the type of users terminal, thereby easily providing comprehensive Internet services for users.

### TECHNICAL FIELD

The present invention relates to a software system which can be applied to web site publication on wire/wireless Internet, and more particularly, to conversion of content, management tools, and web site publication tools.

With development of Internet, HyperText Markup Language (HTML) has been proposed as an international standard for defining a document format which can be shared and published on the Internet. With appearance of a HyperText Transfer Protocol (HTTP) for allowing transfer of HTML documents, a World Wide Web (WWW) environment, in which general users can access HTML documents published over the Internet using browsers in personal computers, was constructed for the first time.

With the appearance of the WWW, the number of web sites has tremendously increased for last several years. Such web sites are managed by web servers and transfers HTML documents at users request.

### BACKGROUND ART

As the number of web sites increases, web site publication tools have been developed. Conventional web site publication tools are mainly HTML editors or generators and perform a function of helping the generation of interconnection between HTML files constituting web sites.

The conventional web site publication tools only help users to generate HTML files of static content but cannot provide a function of dynamically processing and converting content into HTML files. Accordingly, in order to generate dynamic HTML files, a web programming interface standard referred to as a Common Gateway Interface (CGI) has been proposed, and many types of web programming language complying with the CGI standard have been developed.

Besides, appearance of wireless Internet brings appearance of separate standards for a document format in addition to HTML. A representative protocol for the wireless Internet and a representative standard for defining a document format on the wireless Internet are a Wireless Application Protocol (WAP) and a Wireless Markup Language (WML) which are proposed by the Wireless Application Forum. Besides, Handheld Devices Markup Language (HDML) and simplified HTML have been proposed for the wireless Internet. At present, these standards are adopted by mobile communication companies in the world.

Conventional representative web site publication tools are DreamWeaver produced by Macromedia, FrontPage produced by Microsoft, and Fusion produced by NetObjects. These web site publication tools provide a function of generating HTML web pages by way of What You See Is What You Get (WYSIWYG) and a function of setting a linkage between HTML pages and checking the linkage over a Graphic User Interface (GUI), thereby allowing content based on HTML to be published as a web site.

However, these web site publication tools are limited to a function of generating static HTML files and cannot be used as tools for converting dynamic content existing in a database, a file, or an arbitrary web to generate an HTML document in real time.

Oracle has introduced a product referred to as Portal-to-Go for supporting real-time content conversion and publication on the wire or wireless Internet. The Portal-to-Go has a function of expressing basic content in Extensible Markup Language (XML) and converting dynamic content existing on a database, a file, or an arbitrary web in real time and allows content converted into XML to be published in a particular language such as HTML, WML, or HDML used on the wire or wireless Internet.

However, conventional technology supporting dynamic content conversion and publication lacks an automatic generation function of a program for dynamically generating HTML in web site publication and lacks a real-time conversion function for various multimedia data including images, audio, and video.

### DISCLOSURE OF THE INVENTION

To solve the above-described problems, it is a first object of the present invention to provide a content publication system for integrating and processing multimedia content including dynamic data in real time to generate content for each device and publishing a program for integrating and processing dynamic data on wire or wireless Internet.

It is a second object of the present invention to provide a method of integrating and processing multimedia content including dynamic data in real time.

It is a third object of the present invention to provide a method of publishing a program having a function of integrating and processing multimedia content including dynamic data in real time.

To achieve the first object of the present invention, there is provided a content publication system supporting real-time integration and processing of multimedia content including dynamic data. The content publication system includes a repository having a content repository described by a predetermined internal description, which is capable of integrating a plurality of static and dynamic content, in unit of containers, a converter object repository for storing output format conversion rules for different devices, and a media converter repository for converting multimedia data to be suitable for the characteristics of each device; and a service publication server for fetching a corresponding container from the content repository in response to a content request received from a web server, accessing dynamic content using dynamic content access information included in the fetched container, integrating the dynamic content with static content in real time, converting the integrated content according to an output format conversion rule fetched from the converter object repository for a corresponding device, and when multimedia data is included in the fetched container, converting multimedia data to be suitable for the characteristics of the device and transmitting the result of conversion to the web server for the delivery to the device.

The service publication server further includes a program publication function of receiving a program publication request from a service producer, fetching a corresponding container from the content repository, generating a tag for accessing dynamic content using dynamic content access information included in the fetched container, embedding the tag into static content, converting the static content including the tag according to output format conversion rules fetched from the converter object repository for different devices to generate programs for different device output formats, and storing the programs in the web server.

To achieve the second object of the present invention, there is provided a method for integrating and processing multimedia content including dynamic data in real-time. The method includes the steps of (a) generating a repository including a content repository described by a predetermined internal expression, for integrating a plurality of static and dynamic content, in unit of containers, and a converter object repository for storing output format conversion rules for different devices, (b) receiving a content request from a web server and fetching a container corresponding to the content request from the content repository, (c) accessing dynamic content using dynamic content access information included in the fetched container and integrating the one or more dynamic content with static content in real time, (d) converting the integrated content according to an output format conversion rule fetched from the converter object repository for a corresponding device, converting multimedia data to be suitable for the characteristics of the device when the fetched container includes the multimedia data, and transmitting the result of conversion to the web server for the delivery to the device.

To achieve the third object of the present invention, there is provided a method of publishing a program supporting real-time integration and processing of multimedia content including dynamic data. The method includes the steps of (a) generating a repository including a content repository described by a predetermined internal expression, for integrating a plurality of static and dynamic content, in unit of containers, and a converter object repository for storing output format conversion rules for different devices, (b) receiving a program publication request from a service producer and fetching a container corresponding to the content request from the content repository, (c) generating a tag for accessing dynamic content using dynamic content access information included in the fetched container and embedding the tag into static content, (d) converting the static content including the tag according to output format conversion rules fetched from the converter object repository for different devices and generating programs for different device output formats, and (e) storing the programs in the web server for delivering content for different device output formats.

### BRIEF DESCRIPTION OF THE DRAWINGS

The above objects and advantages of the present invention will become more apparent by describing in detail a preferred embodiment thereof with reference to the attached drawings in which:

FIG. 1 is a diagram of the entire configuration of a content publication system according to the present invention and related services;

FIG. 2 is a diagram of a conventional method of publishing Internet content;

FIG. 3 is a diagram of a first method by which a service publication system is operated according to the present invention;

FIG. 4 is a diagram of a second method by which a service publication system is operated according to the present invention;

FIG. 5 is a detailed diagram of a service publication system according to an embodiment of the present invention;

FIG. 6 is a diagram of an environment in which a service publication system according to the embodiment of the present invention is used;

FIG. 7 is a diagram for explaining a procedure of operating a container fetched from a repository; and

FIG. 8 is a diagram of the format of a container identifier.

### BEST MODE FOR CARRYING OUT THE INVENTION

Hereinafter, the present invention will be described in detail with reference to the attached drawings. The present invention relates to a system for extracting data from various data sources, converting the extracted data into internal content for management, and integrating internal content with data, which is extracted from existing data sources in real time, to publish a new service on wire/wireless Internet. The present invention does not specifically restrict a means of expressing internal content, but it is assumed that Extensible Markup Language (XML) is used in an embodiment of the present invention. In addition, a service covers all of a series of published content which can interact with a final user, including programs and data published according to the present invention.

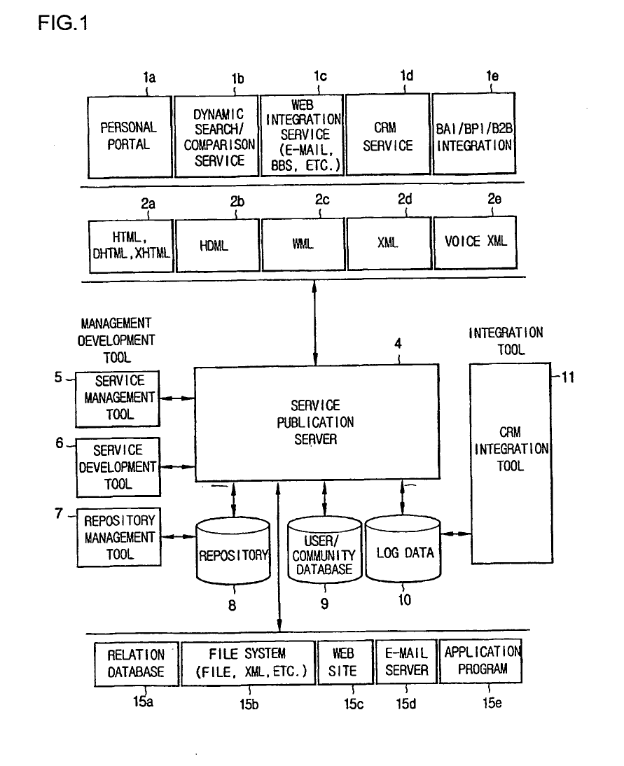

FIG. 1 illustrates the configuration of a preferred embodiment of a service publication system according to the present invention, services which can be published by the present invention, and data sources which can be integrated by the present invention. As an embodiment of a content publication system having a function of integrating and processing multimedia content including dynamic data in real time according to the present invention, the service publication system includes a service publication server 4 which is the core of service publication, a service development tool 6 provided for a service producer, a service management tool 5 for managing published services, a repository management tool 7 for integrally managing content which will be used for publication, a repository 8, a user/community database 9, log data 10, and a customer relationship management (CRM) integration tool 11 for recording and managing a log about users access to the service publication server 4 and helping the integration with a CRM system (not shown).

The service publication server 4 basically includes both a service operating function and a service configuring function. In addition, the service publication server 4 includes a function of changing the content or configuration of a service during an operation of the service.

The service configuring function includes configuring various content to be included in a service in internal expression, i.e., XML, storing them in the repository 8, and publishing the content stored in the repository 8 as a program. A service producer is provided with the service configuring function of the service publication server 4 through the service development tool 6.

The service operating function includes publishing content stored in the repository 8 in real time at a users request. Basically, the repository 8 may store data produced by a service producer in advance (hereinafter referred to as static data) and data brought from various data sources in real time (hereinafter referred to as dynamic data). Data can be images, audio, video, or multimedia data such as electronic mail (e-mail) composed of images, audio, and video and is not restricted thereto. In the case of publishing content requested by a user, if dynamic data is included in the content, the service publication server 4 is provided with the dynamic data from a corresponding data source. The service publication server 4 can be provided with data from data sources such as a relational database system 15a, a file system 15b, a web site 15c on the Internet, an e-mail server 15d, and an application program 15e providing result data in XML. These data sources are only examples, and the present invention is not restricted thereto. For dynamic data, the service publication server 4 may be provided with a data filtering function of extracting only data satisfying the search conditions in accordance with a given users request and a function of integrating data from a plurality of data sources in a unified format.

The format of content published by the service publication server 4 in real time is not restricted to a particular one but may be formats based HyperText Markup Language (HTML) 2a, Handheld Devices Markup Language (HDML) 2b, Wireless Markup Language (WML) 2c, XML 2d, Voice XML 2e, etc.

The service publication server 4 manages the user/community database 9 so that different content can be provided for each user or community. A service utilizing such a function may be a personal portal 1a. The personal portal 1a is a service for allowing a user to configure and modify a personal web site to his/her taste.

In addition, the service publication server 4 records the log data 10 about each user's use of a service so that it can be known what content have been accessed by the corresponding user during operation of a service. The CRM integration tool 11 analyzes the log data 10 so that a service suitable for the users request can be provided.

The service publication server 4 can publish services of a new conception in addition to all types of services which can be published by a conventional web site publication method. In other words, services which can be published by the service publication server 4 include the personal portal 1a, a dynamic search/comparison service 1b, a web integration service 1c, a CRM service 1d, and a business application integration (BAI)/business process integration (BPI)/business-to-business (B2B) integration 1e, but is not restricted thereto. The dynamic search/comparison service 1b provides an integrate search service for integrating data from various data sources and allowing for search based on search conditions. The web integration service 1c integrates the content of various services existing on a web and provides the result of integration. The web integration service 1d may include integration of e-mail services and integration of bulletin board systems. The CRM service 1d is an e-mail marketing service for sending information satisfying a users request to the user by, for example, e-mail, based on data analyzed using the CRM integration tool 11. The BAI is a service for integrating application programs used within a company. The BPI is a service for integrating internal business. The B2B integration is a service for integrating business between companies. According to the present invention, such services can use data from any data source to provide the data to a user and transmit published data to the users terminals regardless of the type of the users terminal and a document format used in the users terminal.

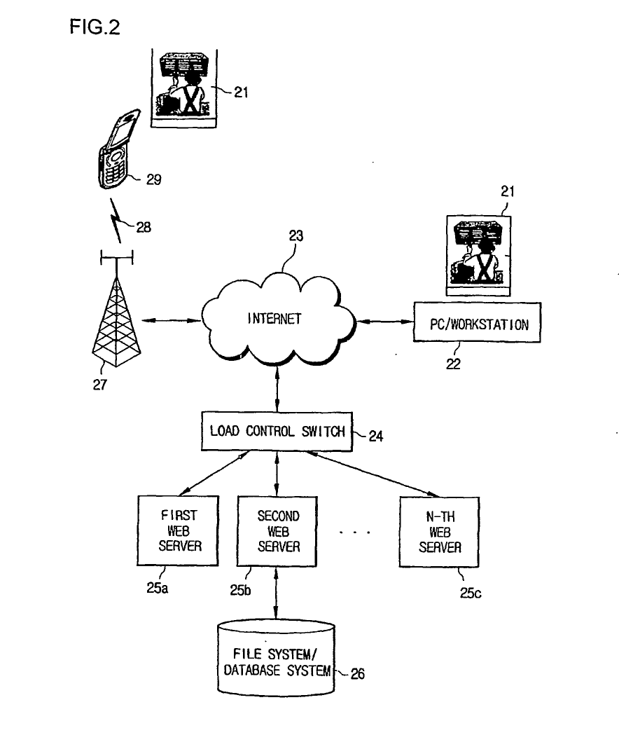

Referring to FIG. 2, in a conventional Internet content publication method, a user 21 can access a wired Internet 23 using a personal computer (PC) or workstation 22 or access a wireless communications network 27 and 28 connected to the wired Internet 23 using a mobile terminal 29 such as a cellular phone. Various web servers 25a, 25b, and 25c on the Internet fetch required content from a file system or database system 26 and provide Internet services requested by the user 21. Here, a load control switch 24 controls the communication loads on the web servers 25a, 2b, and 25c accessed.

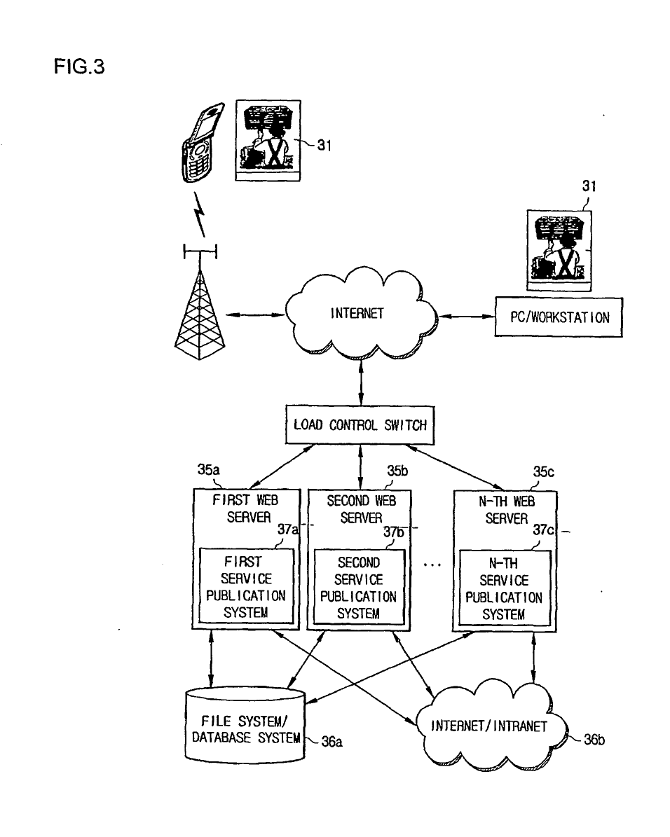

As compared to FIG. 2, each of service publication systems 37a,37b, and 37c, as an embodiment of a content publication system for supporting real-time integration and processing of multimedia content including dynamic data, can be installed in and operated by a web server 35a, 35b, or 35c, as shown in FIG. 3. Each of the service publication system 37a, 37b, and 37c can acquire dynamic data not only from a file system or database system 36a but also from various data sources on an Internet/Intranet 36b and provide the acquired dynamic data to a user 31 accessing thereto through wire/wireless Internet in real time.

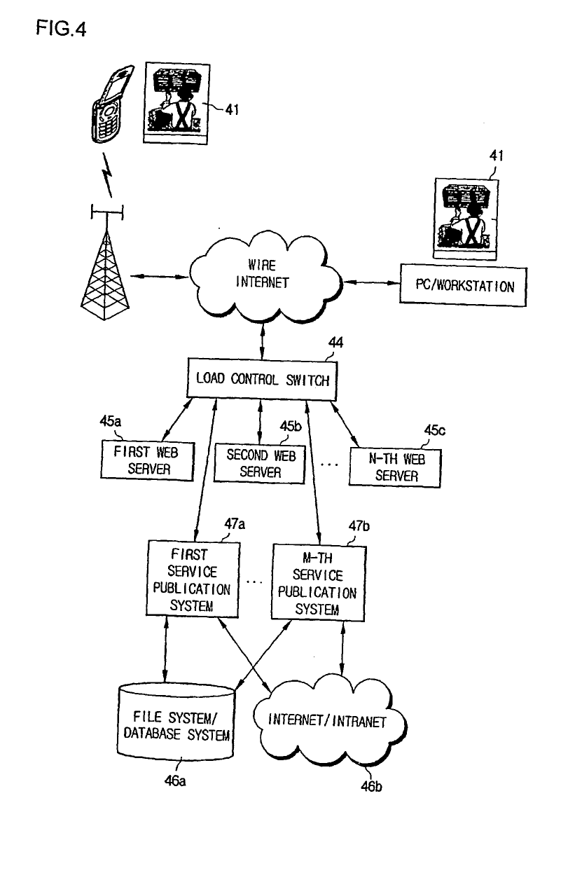

As shown in FIG. 4, each of service publication systems 47a and 47b, as another embodiment of a content publication system for supporting real-time integration and processing of multimedia content including dynamic data, can be operated separately from a web server 45a, 45b, or 45c. Here, a load control switch 44 controls the loads on the accessed web servers 45a, 45b, and 45c and the loads on the accessed service publication systems 47a and 47b. As in FIG. 3, each of the service publication systems 47a and 47b can acquire dynamic data not only from a file system or database system 46a but also from various data sources on an Internet/intranet 46b and provide the acquired dynamic data to a user 41 accessing thereto through wire/wireless Internet in real time.

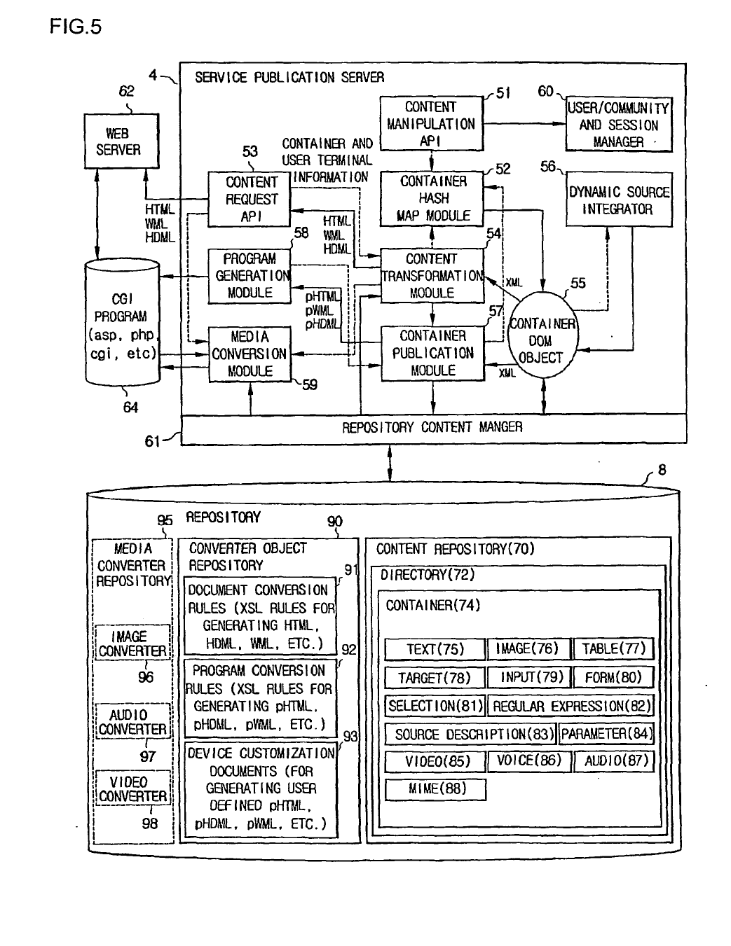

FIG. 5 illustrates the internal configurations of the service publication server 4 and the repository 8 which are the main components of a service publication system as an embodiment of a content publication system for supporting real-time integration and processing of multimedia content including dynamic data according to the present invention.

The repository 8 includes a content repository 70, a converter object repository 90, and a media converter repository 95.

The content repository 70 is used for the service publication server 4 to manage content. A basic logical unit stored in the content repository 70 is a container 74, and one or more containers 74 can be stored in the content repository 70. The containers 74 are stored in a directory 72 having a hierarchical structure, and the directory 72 may include one or more sub-directories. A single container 74 conceptionally indicates a single virtual page of a logical web site. Additionally, the container 74 is a basic unit of storage. In other words, when containers are stored in a file system, a single container 74 is stored in a single file. When containers are stored in a database system, a single container 74 is stored as a single database tuple. According to the present invention, a storage system for storing the container 74 may have arbitrary configuration like a database or file system.

The container 74 can receive dynamic data from a browser of a users terminal. For this, the container 74 may have parameter object 84. The value of each parameter is set to an input value when a browser of a users terminal navigates the container 74. Accordingly, the container 74 can receive the value of the parameter and use the value to generate dynamic content.

The kinds of objects stored in the container 74 are not restricted to ones proposed in this embodiment but can be extended by a service producer using the service publication server 4. The following description concerns detailed objects which can be basically included in the container 74.

A text object 75 indicates an object composed of a character stream and may include static data or dynamic data. When including dynamic data, the text object 75 has a source description object 83. In addition, the text object 75 can have, as an attribute, a target object 78 indicating a link to another container 74.

The source description object 83 contains information for extracting dynamic data. A source from which dynamic data can be extracted may be any medium such as the relational database 15a, the file system 15b, the web site 15c, the e-mail server 15d, or the application program 15e, which can dynamically generate data.

Additionally, when an input value is transmitted to or an output value is received from the data source described in the source description object 83, the conversion of the input value and/or output value can be achived. An object expressing the rules of such conversion is a regular expression object 82. The regular expression object 82 includes a conversion expression for a character stream in a regular expression format. Here, an arbitrary character stream can be converted.

A single target object 78 has the name of the container 74 as an attribute, which allows navigation to the container 74 indicated by the target object 78 when a user selects an object such as a text or a table having the target object 78.

An image object 76 is a multimedia object indicating a bit map image and stores a path to an image file and the attributes of the image file which will be displayed on a terminal. Besides, the multimedia objects include a video object 86, a voice object 86, and an audio object 87. The multimedia object may include static data or dynamic data. When the multimedia object includes static data, it stores media file paths supporting formats suitable for the characteristics of individual terminals because each terminal may support different media format. When the multimedia object includes dynamic data, it does not store a path to a particular file because the format of the dynamic data is converted into a format suitable for the characteristic of each terminal in real time by media.

A multi-purpose Internet mail extension (MIME) object 88 is expressing multimedia data which is transmitted from an e-mail server in the form of mail and stores information such as an e-mail server address, a user login name, and a password which are necessary for e-mail access. The MIME 88 object includes dynamic data. The dynamic data may include multimedia data. Media data included in the dynamic data is converted into a format suitable for the characteristics of each terminal in real time by a media converter.

A table object 77 is expressing data composed of columns and rows. Like the text object 75, the table object 77 may include static data or dynamic data. When the table object 77 include dynamic data, it has the source description object 83. In the case of the table object 77, targets object 78 may exist for respective columns.

An input object 79 expresses an object for receiving a value input by a user. The value input by the user can be transmitted as a parameter to an object of a certain container 74.

A selection object 81 is composed of a list of predetermined values and expresses an object for allowing a user to select a particular value. As in the input object 79, a value selected in the selection object 81 can be transmitted as a parameter to an object of a certain container 74.

A form object 80 can include an arbitrary number of text objects 75, table objects 77, input objects 79, image objects 76, and selection objects 81 in arbitrary order, and is used as a medium for transmitting values obtained from the input objects 79 and the selection objects 81 to a certain container 74. The form object 80 has the target object 78 expressing the container 74 to which the input values are transmitted. In addition, the form object 80 supports both GET and POST of an HTTP protocol as a transmission method.

The converter object repository 90 stores Extensible Stylesheet Language (XSL) rules for converting XML provided from the containers 74 in the content repository 70 into a predetermined output format. The XML provided from the containers 74 is divided into two types. One is transmitted to a content transformation module 54 for real-time content conversion, and the other is transmitted to a content publication module 57 for program publication. The converter object repository 90 stores XSL rules for separately converting the two types of XML. In the case of real-time content conversion, a final output has a document format such as HTML, WML, or HDML which is suitable for a users terminal, so document conversion rules 91 (XSL rules for generating HTML, WML, HDML, etc.) for different document formats are stored in the converter object repository 90. In the case of program publication, a final output has a document format in which special tags expressing program logic is added to a document format suitable for a users terminal, so final outputs are referred to as pHTML, pWML, and pHDML because [symbol] □ is attached to HTML, WML, and HDML to indicate that the final outputs are program-generated documents for convenience sake. Program conversion rules 92 for generating these documents (XSL rules for generating pHTML, pWML, pHDML, etc.) are stored in the converter object repository 90. In addition, the program conversion rules 92 may different depending on devices. To support a document suitable for a particular device, device cutomization documents 93 are stored in the converter object repository 90. A producer can directly compose the device customization documents 93 or compose them using a production tool.

The media converter repository 95 stores converters 96, 97, and 98 for a variety of media (image, audio, and video) content. The converters 96, 97, and 98 can be implemented as programs or Java classes.

The following description concerns the internal configuration of the service publication server 4.

The service publication server 4 is an engine for integrally generating static data and dynamic data and roughly provides a real-time data conversion function including a multimedia conversion function, a program publication function, a content manipulation function, and a user/community and session management function.

According to the real-time data conversion function of the service publication server 4, when a request for the container 74 is transmitted from a web server 62 to a content request API 53, the content request API 53 transmits the request to the content transformation module 54. The request contains container information and uses terminal information.

The content transformation module 54 checks whether the requested container exists in a memory of the service publication server 4 through a container hash map module 52. If the requested container does not exist in the memory, the container hash map module 52 fetches the container from the content repository 70 through a repository content manager 61, loads the container on the memory of the service publication server 4, and converts the container into a container document object model (DOM) object 55. Thereafter, the content transformation module 54 is provided with a document in an XML format from the container DOM object 55. A preferred embodiment of the XML format for the document provided by the DOM object 55 to the content transformation module 54 is specified in Appendix A in XML Document Type Definition (DTD). Before providing the document in the XML format to the content transformation module 54, the container DOM object 55 requests a dynamic source integrator 56 to access external dynamic data when dynamic data is necessary (A related technique is disclosed in an application (U.S. Provisional Patent Application No. 60/208,544) provisionally filed by this applicant in the United States on Jun, 1, 2000.)

The container transformation module 54 requests the repository content manager 61 to fetch a document conversion rule 91 suitable for a users terminal from the converter object repository 90 using the user terminal information contained in the request. Thereafter, the container transformation module 54 transforms the document in the XML format provided from the container DOM object 55 using the document conversion rule 91 suitable for the users terminal provided from the repository content manager 61, and transmits the transformed content (for example, HTML, HDML, or WML) to the web server 62 for the delivery to the device through the content request API 53. A preferred embodiment of the document conversion rule 91 for transforming the document in XML format to HDML format is specified in Appendix B in XSL (XML Stylesheet Language).

When an image, audio, and video (including an image, audio, and video contained in the MIME) are included in the document in the XML format provided from the container DOM object 55, the container transformation module 54 transmits this content to a media conversion module 59 together with the user terminal information. Then, the media conversion module 59 fetches a media converter suitable for the users terminal from the media converter repository 95 through the repository content manager 61, performs conversion with respect to the content, and stores the result of conversion in a particular storage space within the web server 62. Thereafter, the converted content (for example, HTML, HDML, or WML) transmitted to the web server 62 is delivered to the user device user with the converted image, audio or video file in the particular storage space.

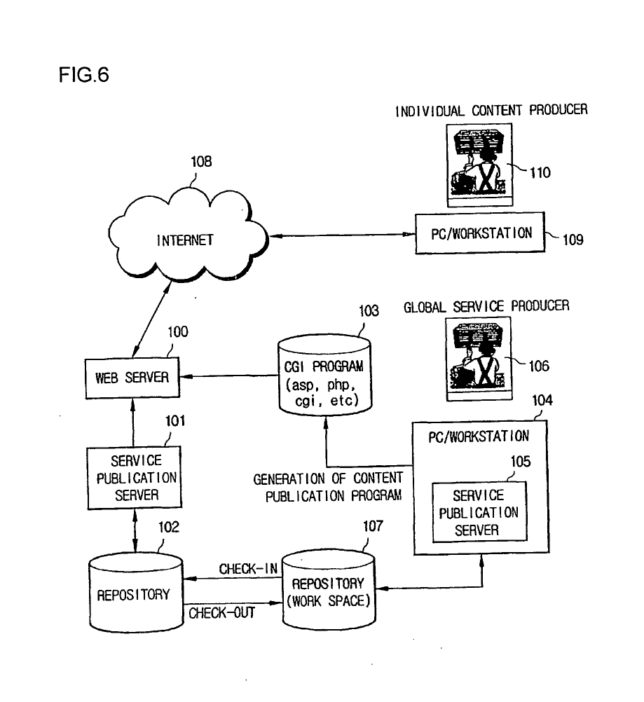

The program publication function of the service publication server 4 will be described with reference to FIGS. 5 and 6.

Referring to FIG. 6, once a global service producer 106 requests program publication using the service development tool 6 of FIG. 1 in his/her PC or workstation 104, a service publication server 105 existing as a component of the service development tool processes the request. The service publication server 105 performs the same functions as the service publication server 4 of FIG. 5. Then, the content manipulation API 51 of the service publication server 4 checks whether a container 74 to be published exists in a memory of the service publication server 4 through the container hash map module 52. If the container 74 does not exist in the memory, the container hash map module 52 fetches the container 74 from the content repository 70 through the repository content manager 61, loads the container 74 on the memory of the service publication server 4, and converts the container 74 into the container DOM object 55. Thereafter, the content publication module 57 is provided with a document in an XML format from the container DOM object 55.

The content publication module 57 generates documents in different formats suitable for all types of terminal from static data except a part generating dynamic data in the XML document provided from the container DOM object 55. Here, the generated document formats are, for example, pHTML, pWML, and pHDML which include a special tag, which describes a program for accessing dynamic data, in addition to a document format suitable for each terminal type. The content publication module 57 applies the program conversion rules 92, which are fetched from the converter object repository 90 through the repository content manager 61, to the XML document provided from the container DOM object 55 in order to generate a document format suitable for each terminal type.

The documents in formats suitable for all types of terminals are transmitted to the program generation module 58 and published as complete Common Gateway Interface (CGI) programs (64 of FIG. 5 and 103 of FIG. 6). A program is published in units of containers 74, and a single container is published as programs as many as the number of types of terminals. Here, when the published programs are called by the web servers 90 of FIG. 5 and 100 of FIG. 6, parts corresponding to dynamic data in the called programs are accessed in real time by the dynamic source integrator 56 and integrated into the static data.

Like the case of dynamic data, media conversion is not performed during program publication because different media conversion should be performed in real time depending on a users device. Consequently, the published program requests the media conversion module 59 to convert a relevant medium. The media conversion module 59 fetches a media converter 96, 97, or 98 suitable for the users device from the media converter repository 95 through the repository content manager 61, performs conversion, and stores the result of conversion in a particular storage space within the web server 62. Thereafter, the published program refers to converted image, audio or video file in the particular storage space and transmits it to the user.

The content manipulation function of the service publication server 4 will be described with reference to FIGS. 5 and 6. The content manipulation function allows a content producer (the global service producer 106 or individual content producer 110 of FIG. 6) to manipulate, for example, to modify, add, or delete, content.

When a content producer is not a general web site user but an entire web service constructor, i.e., the global service producer 106, the content producer copies a container to be manipulated from the repository 102, which the service publication server 101 in service accesses, to a repository for work space in his/her PC/workstation 104 (This operation is referred to as check-out). Thereafter, the content producer manipulates the copied content using the service publication server 105 executed in his/her PC/workstation 104. In contrast, when the content producer is a general web site user, he/she uses the service publication server 101 in service, which is accessed by his/her PC/workstation 109 through the web server 100 over the Internet.

No matter what path is used for a service publication server, the content producer can use the content manipulation API 51 in the service publication server. The content manipulation API 51 checks whether the container 74 to be manipulated exists in a memory of the service publication server 4 through the container hash map module 52. If the container 74 does not exist in the memory, the container hash map module 52 fetches the container 74 from the content repository 70 through the repository content manager 61, loads it on the memory of the service publication server 4, and converts it into the container DOM object 55. Thereafter, the content producer modifies or deletes the value of the container converted into the container DOM object or generates a new container using the content manipulation API 51. When storing-of the content of the manipulated container is requested, the manipulated container DOM object 55 is converted into a container in the XML format and then stored in the content repository 70.

The user/community and session management function of the service publication server 4 is performed by the user/community and session manager 60. The user/community and session management function includes checking the authority of a user or community to access a particular content through the content manipulation API 51 and recording the users requests through the content request API 53 in the form of logs.

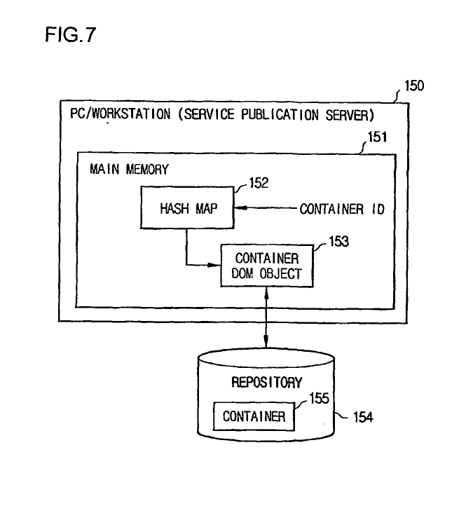

FIG. 7 illustrates a structure in which a container 155 stored in a repository 154 is manipulated in a main memory 151 of a service publication server 150. The container 155 stored as an XML file is loaded onto the main memory 151 by the service publication server 150. The XML file loaded onto the main memory 151 is parsed and expressed as a container DOM object 153 (the container may be stored not in the form of an XML file but in the form of a parsed DOM). Accordingly, when manipulation (such as addition, modification, deletion of attribute) is performed on the container using the content manipulation API 51, the container DOM object 153 is directly manipulated.

A hash map 152 is used for accessing a particular container using an identifier (ID). The hash map 152 receives a container ID and derives the container DOM object 153 currently loaded onto the main memory 151. When stored, the container DOM object 153 is converted into an XML file (or the container DOM object 153 is stored as it is).

When a container is manipulated after being converted from XML into a DOM object, manipulation can be easily performed, and the content can be converted by directly applying XSL rules to the DOM object.

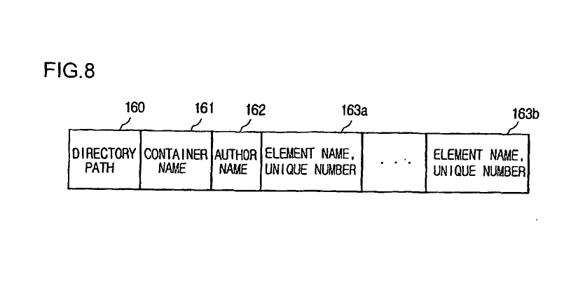

FIG. 8 illustrates a method of encoding a content ID for discriminately identifying a content contained in a container. Basically, all containers can be discriminately identified. Each container is identified by a directory path 160 in a repository storing the container and its author name 162. In addition, content in each container can be discriminated from each other. In other words, each content is identified by a list 163a or 163b of an element name and a unique number, which is added to a container ID. Accordingly, the node of a content can be searched in a container DOM object, at which the content is positioned, based on an element name and a unique number. Here, the element indicates a document type definition (DTD) element expressing a content defined in terms of XML DTD which expresses a type in which the container is stored in XML. The unique number indicates a number uniquely determined in one container.

For example, when a container named “login” is created under a directory “/inetput/wwwroot”, a form object is created within the container, and a text object is created within the form, an ID for identifying the text object can be encoded as follows:

/inetput/wwwroot/login+Form#1+Text#2

By using a content ID encoding method as shown in FIG. 8, an individual content can be easily accessed and manipulated. In other words, when modifying a text object using the hash map 152 of FIG. 7, the container ID (for example, /inetput/wwwroot/login) is transmitted to the hash map 152, and the DOM object of the corresponding container can be searched. Thereafter, the text object contained in the container DOM object can be searched by following a path (for example, Form#1+Text#2). The text object searched through the above method can be directly manipulated.

[image]

[image]

[image]

[image]

[image]

[image]

[image]

[image]

[image]

[image]

[image]

[image]

[image]

[image]

Industrial Applicability

According to the present invention, multimedia content including dynamic data can be processed in real time to generate content for each device, and a service producer can easily publish a program for processing the dynamic data, without using a CGI program. Accordingly, the service producer utilizes dynamic data from various sources without the burden of content conversion which is different depending on the type of users terminal, thereby easily providing comprehensive Internet services for users.

While this invention has been particularly shown and described with reference to preferred embodiments thereof, it will be understood by those skilled in the art that various changes may be made within the scope which does not beyond the essential characteristics of this invention. Therefore, the above embodiments have been used in a descriptive sense only and not for purpose of limitation. It will be understood that the scope of the invention will be defined not by the above description but by the appended claims, and all differences within the scope defined by the claims are covered by the present invention.

What is claimed is:

1. A content publication system supporting real-time integration and processing of multimedia content including dynamic data, characterized by comprising:
a repository comprising a content repository described by a predetermined internal expression, which is capable of integrating a plurality of static and dynamic content including multimedia data, in unit of containers, a converter object repository for storing output format conversion rules for different devices, and a media converter repository for storing media converters for various types of media content and converting multimedia data to be suitable for the characteristics of each device; and
a service publication server for fetching a corresponding container from the content repository in response to a content request received from a web server, accessing dynamic content using dynamic content access information included in the fetched container, integrating the dynamic content with static content in real time, converting the integrated content according to an output format conversion rule fetched from the converter object repository for a corresponding device, and when multimedia data is included in the fetched container, converting multimedia data to be suitable for the characteristics of the device and transmitting the result of conversion to the web server for the delivery to the device.

2. The content publication system of claim 1, wherein the service publication server comprises:
a content request API for receiving the content request from the web server and transmitting content corresponding to the content request to the web server;
a content transformation module for integrating the static content and the dynamic content which are included in the container corresponding to the content request from the content request API, converting the integrated content according to the output format conversion rule for the device, and transmitting the result of conversion to the content request API;
a repository content manager for fetching the container and the output format conversion rule from the repository;
a media conversion module for converting static and dynamic media content included in the container fetched by the repository content manager using a corresponding multimedia converter fetched from the media converter repository, and transmitting the result of conversion to the web server; and
a dynamic source integrator for accessing the dynamic content in real time using the dynamic content access information included in the container fetched by the repository content manager and integrating the dynamic content with the static content.

3. The content publication system of claim 2, wherein the content transformation module applies XML Stylesheet Language (XSL) rules as the output format conversion rule to convert the integrated content described in an XML document to each client device format, the Document Type Definition (DTD) for the XML document defines the common features of different markup languages such as WML, HDML, c-HTML, and HTML, and the XSL rules define conversion to each wireless markup language.

4. The content publication system of claim 2, wherein the repository content manager keeps the fetched container in a main memory in the form of a document object model (DOM) object in extensible markup language (XML).

5. The content publication system of claim 3, wherein the service publication server further comprises a container hash map module for receiving a container identifier and checking whether a corresponding DOM object has been loaded on a memory.

6. The content publication system of claim 1, wherein the service publication server further comprises a program publication function of receiving a program publication request from a service producer, fetching a corresponding container from the content repository, generating a tag for accessing dynamic content using dynamic content access information included in the fetched container, embedding the tag into static content, converting the static content including the tag according to output format conversion rules fetched from the converter object repository for different devices to generate programs for different device output formats, and storing the programs in the web server.

7. The content publication system of claim 5, wherein the service publication server comprises:
a content manipulation API for receiving the program publication request from the web server;
a content publication module for generating the tag for accessing the dynamic content using the dynamic content access information included in the container corresponding to the program publication request, embedding the tag into the static content, and converting the static content including the tag according to the output format conversion rules fetched from the converter object repository to generate documents for the different device output formats;
a repository content manager for fetching the container and the output format conversion rules from the repository;
a program generation module for converting each of the documents for the different device output formats into a common gateway interface (CGI) program;
a dynamic source integrator for accessing the dynamic content at a request of the CGI program and transmitting the dynamic content to the CGI program; and
a media conversion module for converting media content included in the dynamic content requested by the CGI program using a corresponding media converter fetched from the media converter repository and transmitting the result of conversion to the CGI program.

8. The content publication system of claim 6, wherein the repository content manager keeps the fetched container in a main memory in the form of a document object model (DOM) object in extensible markup language (XML).

9. The content publication system of claim 7, wherein the service publication server further comprises a container hash map module for receiving a container identifier and checking whether a corresponding DOM object has been loaded on a memory.

10. The content publication system of claim 7, wherein the content manipulation API further comprises a function of modifying a container value in the DOM object loaded on the memory, deleting a selected container from the repository, and generating a new container in the repository.

11. The content publication system of claim 1 or 5, wherein the service publication server further comprises a function of checking a users or communities right to access the content and recording a log about the content request from the web server.

12. A method for integrating and processing multimedia content including dynamic data in real-time, characterized by comprising the steps of:
(a) generating a repository comprising a content repository described by a predetermined internal expression, for integrating a plurality of static and dynamic content, in unit of containers, and a converter object repository for storing output format conversion rules for different devices;
(b) receiving a content request from a web server and fetching a container corresponding to the content request from the content repository;
(c) accessing one or more dynamic content using dynamic content access information included in the fetched container and integrating one or more dynamic content with static content in real time;
(d) converting the integrated content according to an output format conversion rule fetched from the converter object repository for a corresponding device and transmitting the converted content to the web server for delivery to the corresponding device.

13. The method of claim 11, wherein the repository generated in step (a) further comprises a media converter repository for storing media converters for various types of media content, and
the method further comprises the steps of:
(e) converting media content included in the container fetched in step (b) using a corresponding media converter fetched from the media converter repository and storing the converted media content in a predetermined storage unit of the web server; and
(f) adding the converted media content stored in step (e) to the content to be transmitted to the web server in step (d) and providing the result of addition to the web server.

14. The method of claim 11, wherein the integrated content generated in step (c) is described in an XML document and the conversion process of step (d) applies XML Stylesheet Language (XSL) rules as the output format conversion rule to convert the integrated document to each client device format.

15. A method of publishing a program supporting dynamic data processing, characterized by comprising the steps of:
(a) generating a repository comprising a content repository described by a predetermined internal expression, for integrating a plurality of static and dynamic content, in unit of containers, and a converter object repository for storing output format conversion rules for different devices;
(b) receiving a program publication request from a service producer and fetching a container corresponding to the content request from the content repository;
(c) generating a tag for accessing dynamic content using dynamic content access information included in the fetched container and embedding the tag into static content;
(d) converting the static content including the tag according to output format conversion rules fetched from the converter object repository for different devices and generating programs for different device output formats; and
(e) storing the programs in the web server for the delivery to different device output formats.
